(19) United States
(12) Patent Application Publication
(10) Pub. No.: US 2013/0232317 A1
(43) Pub. Date: Sep. 5, 2013

(54) VECTOR PROCESSING APPARATUS AND VECTOR PROCESSING METHOD

(71) Applicant: Masao YASUDA, Tokyo (JP)

(72) Inventor: Masao YASUDA, Tokyo (JP)

(21) Appl. No.: 13/781,945

(22) Filed: Mar. 1, 2013

(30) Foreign Application Priority Data
Mar. 1, 2012 (JP) 2012-045821

(51) Int. Cl. G06F 15/80

(52) U.S. Cl. CPC G06F 15/8053
USPC 712/2

(57) ABSTRACT

A vector processing apparatus includes a storage pointer generation unit and an instruction execution unit including a plurality of vector pipeline units. The storage pointer generation unit receives the vector instruction and range information thereof and generates the storage pointer value. When receiving a succeeding vector instruction being able to be processed in parallel together with a preceding vector instruction, the storage pointer generation unit updates the storage pointer value based on the range information so as to input each element of the succeeding vector instruction into a vector pipeline unit that is unused by the preceding vector instruction, and the instruction execution unit processes in parallel the preceding vector instruction and the succeeding vector instruction according to the storage pointer value.

### INCORPORATION BY REFERENCE

This application is based upon and claims the benefit of priority from Japanese patent application No. 2012-045821, filed on Mar. 1, 2012, the disclosure of which is incorporated herein in its entirety by reference.

### BACKGROUND OF THE INVENTION

1. Technical Field

The present invention relates to a vector processing apparatus and a vector processing method. In particular, the present invention relates to a vector processing apparatus and a vector processing method, capable of improving the vector processing efficiency.

2. Background Art

In recent vector machines, their processing is performed through parallel pipelines. Techniques related to the present invention are disclosed in, for example, Published Japanese Translation of PCT International Publication for Patent Application, No. 2008-535115, Japanese Unexamined Patent Application Publications No. 09-198374, No. 08-314897, No. 01-205269, and No. 61-290570.

However, in a vector machine in which processing is performed through parallel pipelines, when vector processing is performed for elements that are less than the parallel level, the pipelines are not fully used and the processing efficiency thereby deteriorates. Further, when a vector instruction having a short vector length is repeated, the processing efficiency also deteriorates due to the overhead that occurs at the beginning of the execution. Therefore, there has been a problem that processing cannot be efficiently performed for short-vector processing in comparison to ordinary long-vector processing performed in a vector machine.

### SUMMARY

The present invention have been made to solve the problem like this, and an object thereof is to provide a vector processing apparatus and a vector processing method, capable of improving the vector processing efficiency.

In an exemplary aspect of the invention, a vector processing apparatus includes: a storage pointer generation unit that generates a storage pointer value; and an instruction execution unit that includes a plurality of vector pipeline units and performs parallel processing of an operation of a vector instruction including a plurality of elements by using a part of or all of the plurality of vector pipeline units. The storage pointer generation unit receives the vector instruction and range information thereof and generates the storage pointer value indicating a position of use of the plurality of vector pipeline units based on the range information. When receiving a succeeding vector instruction being able to be processed in parallel together with a preceding vector instruction, the storage pointer generation unit updates the storage pointer value based on the range information so as to input each element of the succeeding vector instruction into a vector pipeline unit that is unused by the preceding vector instruction. Then the instruction execution unit processes in parallel the preceding vector instruction and the succeeding vector instruction being able to be processed together with the preceding vector instruction according to the storage pointer value.

In another exemplary aspect of the invention, a vector processing method for a vector processing apparatus includes an instruction execution unit comprising a plurality of vector pipeline units. The vector processing method includes a storage pointer generation step of generating a storage pointer value indicating a position of use of the plurality of vector pipeline units, and an instruction execution step of performing parallel processing of an operation of the vector instruction including a plurality of elements by the plurality of vector pipeline units. The vector instruction includes range information specifying a range of use of the plurality of vector pipeline units. In the storage pointer generation step, when a succeeding vector instruction being able to be processed in parallel together with an preceding vector instruction is received, the storage pointer value is updated based on the range information so that each element of the succeeding vector instruction is input into a vector pipeline unit that is unused by the preceding vector instruction. In the instruction execution step, the preceding vector instruction and the succeeding vector instruction being able to be processed together with the preceding vector instruction are processed in parallel according to the storage pointer value.

### BRIEF DESCRIPTION OF THE DRAWINGS

FIG. 1 shows a configuration of a vector processing apparatus according to a first exemplary embodiment;

FIG. 2 shows a configuration of a storage pointer generation unit according to a first exemplary embodiment;

FIG. 3 shows a configuration of an instruction execution unit according to a first exemplary embodiment;

FIG. 4 is a diagram for explaining processing performed in an ordinary vector machine;

FIG. 5 is a diagram for explaining processing performed in a vector processing apparatus according to a first exemplary embodiment;

FIG. 6 is a diagram for explaining processing efficiency in a vector machine according to a first exemplary embodiment; and

FIG. 7 shows a configuration of an essential part of a vector machine according to the present invention.

### EXEMPLARY EMBODIMENT

Specific exemplary embodiments to which the present invention is applied are explained hereinafter in detail with reference to the drawings. The same components are denoted by the same symbols throughout the drawings, and duplicated explanation is omitted as necessary for clarifying the explanation.

### First Exemplary Embodiment

### [Explanation of Configuration]

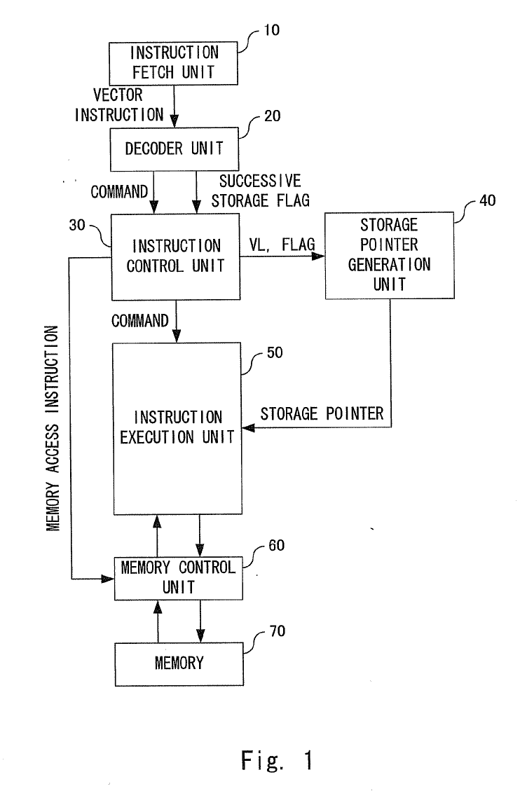

FIG. 1 shows a configuration example of a vector processing apparatus according to this exemplary embodiment of the present invention. The vector processing apparatus includes a storage pointer generation unit 40 that generates a storage pointer value and an instruction execution unit 50 that includes a plurality of vector pipeline units and performs parallel processing of an operation of a vector instruction including a plurality of elements by using a part of or all of the plurality of vector pipeline units. Then the storage pointer generation unit 40 receives the vector instruction and range information thereof and generates the storage pointer value indicating a position of use of the plurality of vector pipeline units based on the range information. When receiving a succeeding vector instruction which is able to be processed in parallel together with a preceding vector instruction, the storage pointer generation unit 40 updates the storage pointer value based on the range information so as to input each element of the succeeding vector instruction into a vector pipeline unit that is unused by the preceding vector instruction. Then the instruction execution unit 50 processes in parallel the preceding vector instruction and the succeeding vector instruction which is able to be processed together with the preceding vector instruction according to the storage pointer value.

The vector processing apparatus further includes an instruction fetch unit 10, a decoder unit 20, an instruction control unit 30, a memory control unit 60, and a memory 70.

The instruction fetch unit 10 fetches a program from the memory 70 and sends a vector instruction to the decoder unit 20. In this exemplary embodiment, the vector instruction includes a successive storage flag and a vector length of vector data that is the target of the vector instruction. The successive storage flag is information for instructing the storage of a vector element into a vector register together with the preceding instruction. The vector processing apparatus can specify a range of use of a vector register (a range of use of a vector pipeline unit) by using the successive storage flag like this, and instruct the storage of a vector element into a vector register together with the preceding instruction.

The decoder unit 20 decodes a vector instruction input from the instruction fetch unit 10. When the input vector instruction is a vector instruction including a successive storage flag, the decoder unit 20 sends an instruction (hereinafter also shown as “command” in the drawings), a successive storage flag, and a vector length to the instruction control unit 30.

The instruction control unit 30 performs execution control of the instruction based on the instruction, the successive storage flag, and the vector length supplied from the decoder unit 20. Specifically, upon receiving the instruction (command), the successive storage flag, and the vector length from the decoder unit 20, the instruction control unit 30 supplies the vector length (hereinafter also shown as “VL” in the drawings) and the successive storage flag to the storage pointer generation unit 40 (which is described later).

Further, when the received instruction (command) is a memory access instruction such as a load instruction, the instruction control unit 30 instructs the memory control unit 60 to access the memory. The instruction control unit 30 controls the data exchange necessary for executing the instruction between the vector register(s) of the instruction execution unit 50 and the memory 70 through the memory control unit 60.

Further, when the received instruction (command) is a vector element storage instruction to the vector register(s) of the instruction execution unit 50 or a vector element read instruction, the instruction control unit 30 sends an instruction (command) for executing the instruction to the instruction execution unit 50.

Further, when the received instruction (command) is an instruction for arithmetic processing such as an addition, the instruction control unit 30 sends an instruction (command) for executing the addition instruction to the instruction execution unit 50. The instruction control unit 30 instructs the instruction execution unit 50 for an operation performed by an arithmetic unit.

The storage pointer generation unit 40 generates a storage pointer indicating the position of the used element of a vector register(s) based on the vector length and the successive storage flag input from the instruction control unit 30. The storage pointer is used to store the vector element into the vector register of the instruction execution unit 50 together with the data string that is stored into the vector register by the previous instruction. The storage pointer is a pointer indicating the storage position of a vector element of a vector register that is the target of the instruction. The start number of the vector element of the vector register that is the target of the instruction is indicated by using the storage pointer.

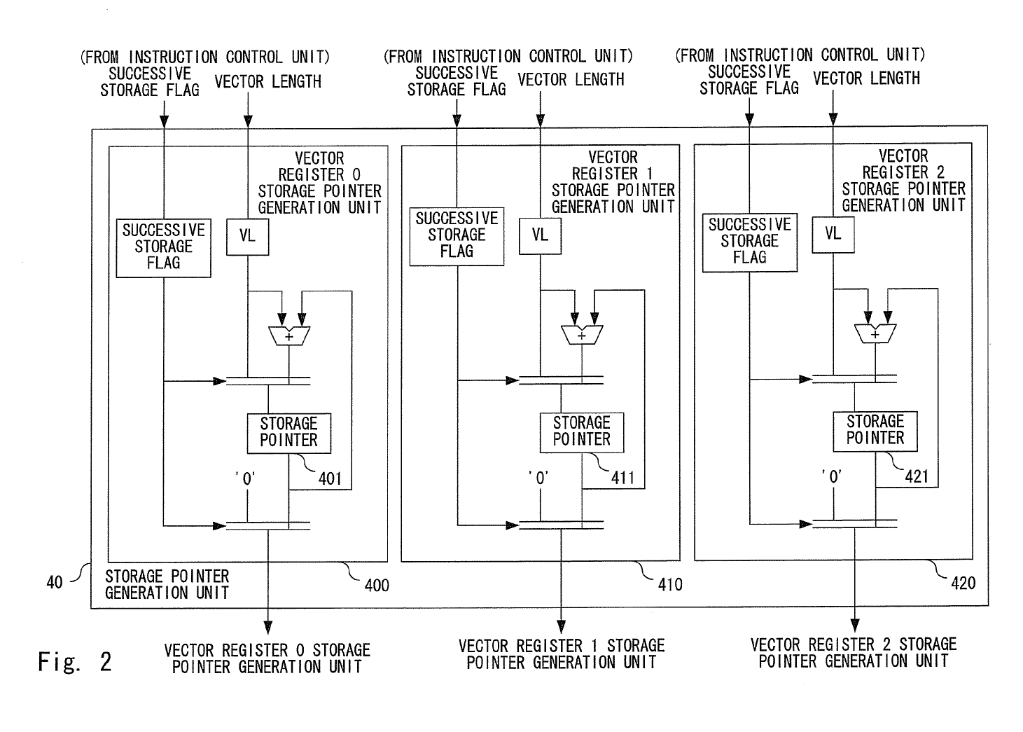

Details of the storage pointer generation unit 40 are explained hereinafter with reference to FIG. 2. FIG. 2 shows a configuration example of the storage pointer generation unit 40. The storage pointer generation unit 40 includes a plurality of vector register storage pointer generation units (vector register 0 storage pointer generation unit 400, vector register 1 storage pointer generation unit 410, and vector register 2 storage pointer generation unit 420). Note that each of the plurality of vector register storage pointer generation units corresponds to a respective one of a plurality of vector registers of the instruction execution unit 50.

When the successive storage flag indicates that a vector element should be successively stored in a vector register of the vector pipeline unit of the instruction execution unit 50, for example, the first unit (the vector register 0 storage pointer generation unit 400) of the storage pointer generation unit 40 sends the currently-held value of the storage pointer 401 to the first vector register (the vector register 520) of each vector pipeline unit 0, VP1, VP2, . . . , VP15 of the instruction execution unit 50 as the value of the vector register 0 storage pointer. Then, each vector register storage pointer generation unit of the storage pointer generation unit 40 adds the vector length (VL) to the currently-held value of each storage pointer and holds the resulting value in the each storage pointer. Note that when the value of the storage pointer exceeds the word number of the vector register, the storing of the excess is continued from the 0th element position.

Whether the successive storage flag indicates that a vector element should be successively stored in a vector register of the instruction execution unit 50 or not may be indicated in the following manner. For example, when the successive storage flag indicates that a vector element should be successively stored in a vector register of the instruction execution unit 50, the value of the successive storage flag is set to “1”, whereas when the successive storage flag does not indicate that a vector element should be successively stored in a vector register of the instruction execution unit 50, the value of the successive storage flag is set to “0”. Further, the successive storage flag is set by the vector processing apparatus.

In FIG. 2, for example, when the successive storage flag for the vector register 0 storage pointer generation unit 400 indicates that a vector element should be successively stored in a vector register of the instruction execution unit 50, it sends the currently-held value of the storage pointer 401 as the vector register 0 storage pointer. Then, the vector register 0 storage pointer generation unit 400 adds the vector length (VL) to the value of the storage pointer 401 and holds the resulting value as the value of the storage pointer 401.

On the other hand, when the successive storage flag does not indicate that a vector element should be successively stored in a vector register of the instruction execution unit 50, the storage pointer generation unit 40 sends, instead of the currently-held value of the storage pointer, information indicating that the storing starts from the element 0 (value “0”) to the instruction execution unit 50 as the value of the vector register storage pointer. Then, the storage pointer generation unit 40 adds the vector length (VL) to the element number 0 and holds the resulting value in the storage pointer.

In FIG. 2, for example, when the successive storage flag for the vector register 0 storage pointer generation unit 400 does not indicate that a vector element should be successively stored in a vector register of the instruction execution unit 50, it sends, instead of the currently-held value of the storage pointer 401, information indicating that the storing starts from the element 0 as the value of the vector register 0 storage pointer. Then, the vector register 0 storage pointer generation unit 400 adds the vector length (VL) to the element number 0 and holds the resulting value as the value of the storage pointer 401. The instruction execution unit 50 executes the instruction based on the instruction (including vector element storage instruction, vector element read instruction, and operation instruction) supplied from the instruction control unit 30 and the storage pointer supplied from the storage pointer generation unit 40. The instruction execution unit 50 includes a plurality of vector pipeline units in which parallel processing is performed. Each of the vector pipeline units includes a plurality of vector registers and at least one arithmetic unit. More than two vector registers of the plurality of vector registers are distributed and placed in respective vector pipeline units.

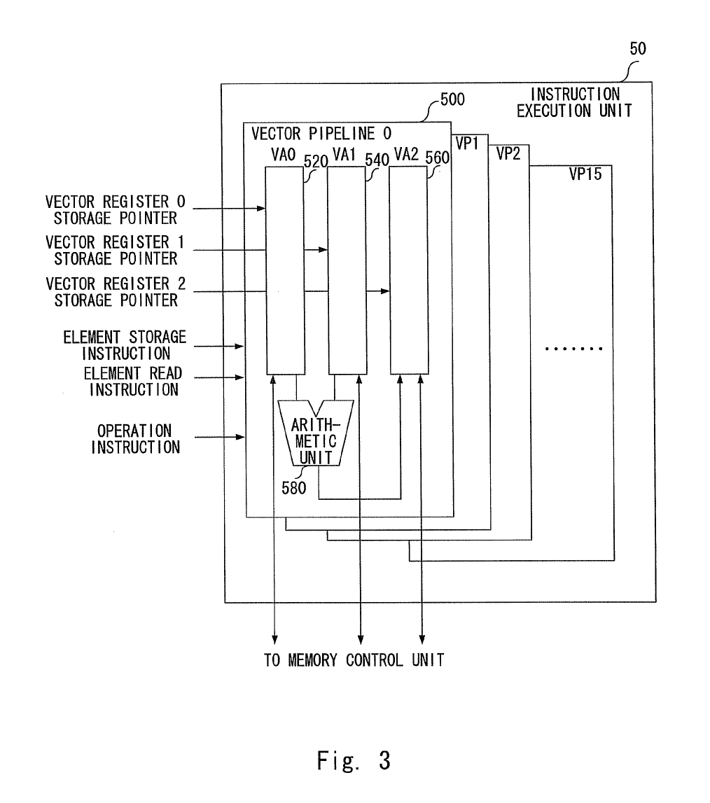

Details of the instruction execution unit 50 are explained hereinafter with reference to FIG. 3. FIG. 3 shows a configuration example of the instruction execution unit 50. The instruction execution unit 50 includes a plurality of vector pipeline units (shown as vector pipeline unit 0, VP1, VP2, . . . and VP15 in the figure). In the figure, for example, the vector pipeline unit 500 includes a plurality of vector registers 520 to 560 (shown as VA0, VA1 and VA2 respectively in the figure) and an arithmetic unit 580. Note that each of the other vector pipeline units (VP1, VP2, . . . and VP 15) has a similar configuration to that of the vector pipeline unit 500, and therefore their detailed explanation is omitted here.

The vector register 0 storage pointer of the storage pointer generation unit 40 is input to the vector register 520 of the vector pipeline unit 500. The vector register 1 storage pointer is input to the vector register 540. The vector register 2 storage pointer is input to the vector register 560.

Note that the storage pointers (vector register 0 storage pointer, vector register 1 storage pointer, and vector register 2 storage pointer) of the storage pointer generation unit 40 are also input to respective vector registers (VA0, VA1 and VA2) of the other vector pipeline units (VP1, VP2, . . . and VP15).

Further, in the following explanation, the vector registers 520 (VA0) of the respective vector pipeline units (vector pipeline unit 0, VP1, VP2, . . . and VP15) may be collectively referred to as “0th vector register(s) of the instruction execution unit 50” for simplifying the explanation. The vector registers 540 (VA1) of the respective vector pipeline units (vector pipeline unit 0, VP1, VP2, . . . and VP15) may be collectively referred to as “first vector register(s) of the instruction execution unit 50”. Further, the vector registers 560 (VA2) of the respective vector pipeline units (vector pipeline unit 0, VP1, VP2, . . . and VP15) may be collectively referred to as “second vector register(s) of the instruction execution unit 50”.

Each of the plurality of vector registers 520 to 560 of the vector pipeline unit 500 stores an element indicated by a vector register storage pointer sent from the storage pointer generation unit 40 in accordance with a vector element storage instruction sent from the instruction control unit 30. Further, each of the plurality of vector registers 520 to 560 reads an element indicated by a vector register storage pointer sent from the storage pointer generation unit 40 in accordance with a vector element read instruction sent from the instruction control unit 30.

For example, the vector register 520 stores an element indicated by a vector register 0 storage pointer sent from the storage pointer generation unit 40 in accordance with a vector element storage instruction sent from the instruction control unit 30. Further, the vector register 520 reads out an element indicated by the vector register 0 storage pointer in accordance with a vector element read instruction.

### [Explanation of Operation]

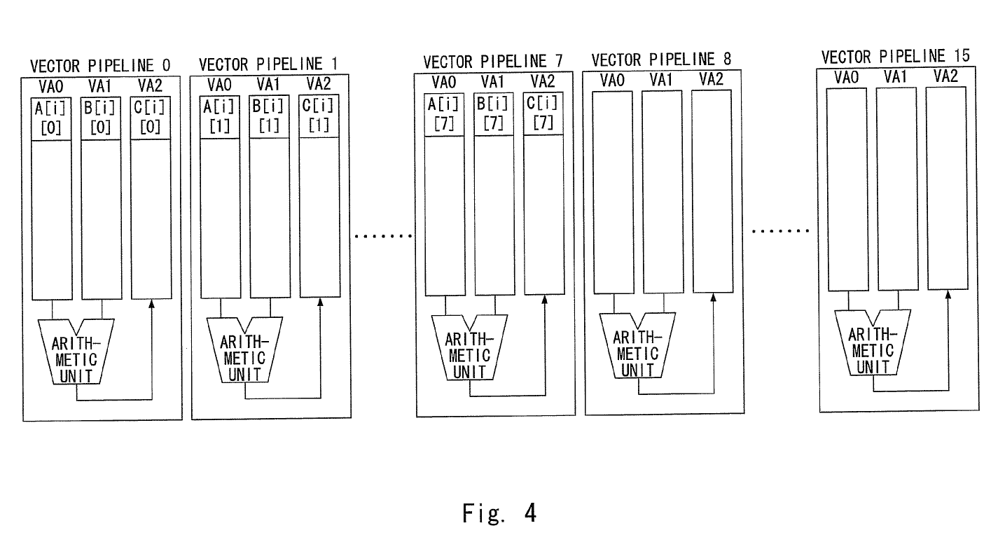

Next, an example of an operation of a vector processing apparatus is explained hereinafter with reference to FIGS. 4 to 6. This exemplary embodiment according to the present invention is explained by using an example of a matrix-addition operation of two-dimensional arrays. A configuration example of a program for implementing this arithmetic processing is shown below. Note that the following example is explained by using an example in which the loop repeat number m is smaller than the parallel level of the pipelines of the vector machine.

The below-shown program is constructed by using double loops. The outer loop is constructed by n loops using a counter i, and the inner loop is constructed by m loops using a counter j.

### [Example of Arithmetic Operation]

for ( i=0 ; i<n ; i++ ) {
for ( j=0 ; j<m ; j++ ) { C[i][j] = A[i][j] + B[i][j] ; }
}

Regarding the loop configuration of the above-shown program, the program is often constructed by replacing the inner loop j with a vector instruction(s) in a vector processing operation performed in an ordinary vector machine. A configuration example of a program that is obtained replacing the inner loop with a vector instruction is shown below.

### [Example of Vector Processing Operation: Configuration Example of Ordinary Program]

Initialize value of i
LOOP:

If value of i becomes smaller than n, escape from loop
From address of A[i], vector-load m pieces of data, into vector register 0
From address of B[i], vector-load m pieces of data, into vector register 1
Vector-add vector register 0 and vector register 1 for m times, into vector register 2
From address of C[i], vector-store m pieces of data of vector register 2
Return to LOOP

In the case where the vector processing like this is performed in an ordinary vector machine, if the value of m is small, the vector length stored in the vector register becomes shorter. As a result, the efficiency of the vector addition sometimes deteriorates.

More specific explanation is made hereinafter. For example, assume a configuration example of a vector processing system in which the maximum vector length is 256 elements and the micro-architecture of the system includes 16 vector pipeline units. In general, vector registers are distributed and placed over the 16 vector pipeline units. As a rule for distributing and placing the vector registers, for example, it is conceivable to use such a method that “among the 16 vector pipeline units, the 0th vector pipeline unit is used for an element(s) for which the remainder of the division of the element number by 16 is 0; and the first vector pipeline unit is used for an element(s) for which the remainder of the division of the element number by 16 is 1”.

However, in the above-described configuration example, for example, when m is 8, only eight vector pipeline units of the 16 vector pipeline units are used for the execution of all the vector instructions (vector load, vector addition, and vector store) in the above-described vector processing operation. Therefore, no processing is performed in the remaining eight vector pipeline units, and thus leading to the deterioration in the processing efficiency. (As shown in FIG. 4, only vector pipeline units 0 to 7 are used, and no processing is performed in vector pipeline units 8 to 15).

Accordingly, this exemplary embodiment according to the present invention makes it possible to combine a plurality of short vector processes into one long vector process by introducing a mechanism which is explained below as an example. Specifically, an instruction string of a program which is shown below as an example is introduced.

[Example of Vector Processing Operation According to this Exemplary Embodiment]
Initialize value of i
LOOP:

If value of i becomes smaller than n, escape from loop
From address of A[i], vector-load m pieces of data, into vector register 0, successive storage flag does not indicate successive storage . . . Instruction (1)
From address of A[i+1], vector-load m pieces of data, into vector register 0, successive storage flag indicates successive storage . . . Instruction (2)
From address of B[i], vector-load m pieces of data, into vector register 1, successive storage flag does not indicate successive storage . . . Instruction (3)
From address of B[i+1], vector-load m pieces of data, into vector register 1, successive storage flag indicates successive storage . . . Instruction (4)
Vector-add vector register 0 and vector register 1 for 2*m times, into vector register 2 . . . Instruction (5)
From address of C[i], vector-store m pieces of data of vector register 2, successive storage flag does not indicate successive storage . . . Instruction (6)
From address of C[i+1], vector-store m pieces of data of vector register 2, successive storage flag indicates successive storage . . . Instruction (7)

Increment i by 2
Return to LOOP

Details of an operation of the vector processing apparatus are explained hereinafter in a more specific manner in accordance with each instruction string of the above-shown program. In the items (1) and (2) of the program, loading for addresses A[i] and A[i+1] is performed. In the items (3) and (4) of the program, loading for addresses B[i] and B[i+1] is performed. In the item (5) of the program, addition processing for the data loaded in the items (1) to (4) is performed. In the items (6) and (7) of the program, storing for addresses C[i] and C[i+1] is performed.

Firstly, in the item (1) of the above-described program, when a vector load instruction whose successive storage flag does not indicate successive storage is input to the decoder unit 20, the decoder unit 20 sends the instruction and the vector length m to the instruction control unit 30.

The instruction control unit 30 sends the successive storage flag that does not indicate successive storage and the vector length m to the vector register 0 storage pointer generation unit 400. Since the input successive storage flag does not indicate successive storage, the vector register 0 storage pointer generation unit 400 sends information (vector register 0 storage pointer) indicating that the storing starts from the 0th element position to a corresponding vector register of the instruction execution unit 50 (the 0th vector register of the instruction execution unit 50). Further, the vector register 0 storage pointer generation unit 400 holds the vector length m as the current value of the storage pointer 401.

The instruction control unit 30 sends an instruction instructing to load m pieces of data, of the data stored in the memory 70, from the address A[i], to the memory control unit 60. Further, the instruction control unit 30 sends a storage instruction instructing to start the storing from the element 0, to the 0th vector register of the instruction execution unit 50.

Next, in the item (2) of the above-described program, when a vector load instruction whose successive storage flag indicates successive storage is input to the decoder unit 20, the decoder unit 20 sends the instruction, the vector length m, and the successive storage flag to the instruction control unit 30.

The instruction control unit 30 sends the successive storage flag that indicates successive storage and the vector length m to the vector register 0 storage pointer generation unit 400.

Since the input successive storage flag indicates successive storage, the vector register 0 storage pointer generation unit 400 sends the current value (m) of the storage pointer 401 to the 0th vector register of the instruction execution unit 50. Further, the vector register 0 storage pointer generation unit 400 adds the vector length m to the current value (m) of the storage pointer 401 and holds the resulting value (m+m=2*m) in the storage pointer 401.

The instruction control unit 30 sends an instruction instructing to load m pieces of data, of the data stored in the memory 70, from the address A[i+1], to the memory control unit 60. Further, the instruction control unit 30 sends a storage instruction instructing to start the storing from the element m, to the 0th vector register of the instruction execution unit 50.

In the items (3) and (4) of the above-described programs, loading for data B[i] and B[i+1] is performed. This process is similar to the process performed in the above-described items (1) and (2), and therefore its detailed explanation is omitted here.

Next, in the item (5) of the above-described program, when a vector addition instruction is input to the decoder unit 20, the decoder unit 20 sends the instruction and the vector length 2*m to the instruction control unit 30.

The instruction control unit 30 sends the successive storage flag that does not indicate successive storage and the vector length 2*m to the vector register 2 storage pointer generation unit 420.

Since the input successive storage flag does not indicate successive storage, the vector register 2 storage pointer generation unit 420 sends information (vector register 2 storage pointer) indicating that the storing starts from the 0th element position to the second vector register of the instruction execution unit 50 and holds the vector length 2*m as the value of the storage pointer 421.

The instruction control unit 30 sends an addition instruction for 2*m pieces to the 0th vector register and the first vector register of the instruction execution unit 50. Further, the instruction control unit 30 sends a storage instruction instructing to start the storing from the element 0, to the second vector register of the instruction execution unit 50.

Next, in the item (6) of the above-described program, when a vector store instruction whose successive storage flag does not indicate successive storage is input to the decoder unit 20, the decoder unit 20 sends the instruction and the vector length m to the instruction control unit 30.

The instruction control unit 30 sends the successive storage flag that does not indicate successive storage and the vector length m to the vector register 2 storage pointer generation unit 420.

Since the successive storage flag does not indicate successive storage, the vector register 2 storage pointer generation unit 420 sends information (vector register 2 storage pointer) indicating that the storing starts from the 0th element position to the second vector register of the instruction execution unit 50 and holds the vector length m as the value of the storage pointer 421.

The instruction control unit 30 sends a store instruction instructing to start the storing of m pieces of data from the element 0 from the address C[i] in the memory 70, to the second vector register of the instruction execution unit 50 (read instruction to vector register).

In the item (7) of the program, when a vector store instruction whose successive storage flag indicates successive storage is input to the decoder unit 20, the decoder unit 20 sends the instruction, the vector length m, and the successive storage flag to the instruction control unit 30.

The instruction control unit 30 sends the vector length m and the successive storage flag to the vector register 2 storage pointer generation unit 420.

Since the input successive storage flag indicates successive storage, the vector register 2 storage pointer generation unit 420 sends the current value (m) of the storage pointer 421 to the second vector register of the instruction execution unit 50. Further, the vector register 2 storage pointer generation unit 420 adds the vector length m to the current value (m) of the storage pointer 421 and holds the resulting value (m+m=2*m) in the storage pointer 421.

The instruction control unit 30 sends a store instruction instructing to start the storing of m pieces of data from the element m from the address C[i+1] in the memory 70, to the second vector register of the instruction execution unit 50 (read instruction to vector register).

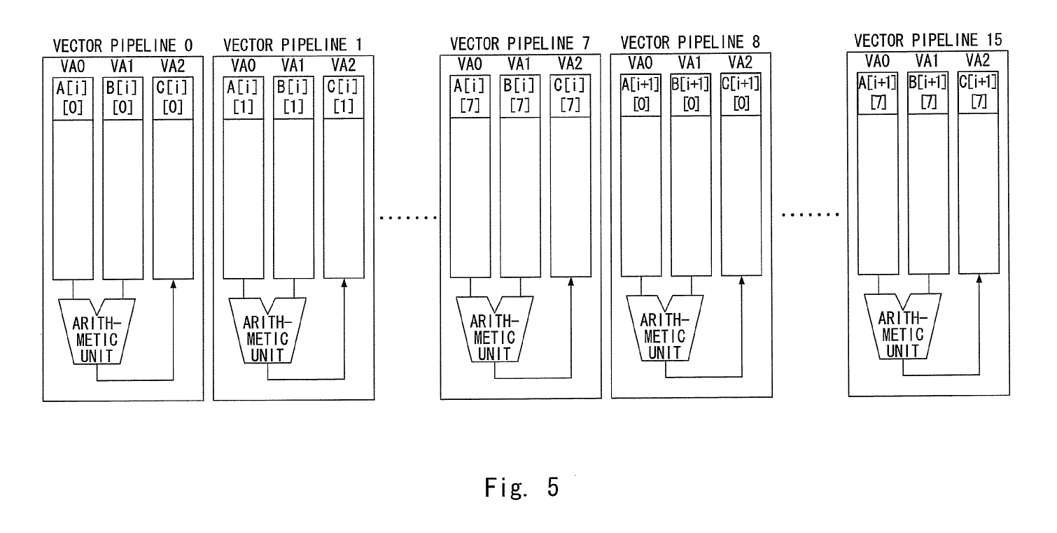

As explained above, in the above-described program, two short vectors are combined into one long vector and vector processing is performed for this combined vector. Therefore, for example, when the vector length m is 8, all of the 16 vector pipeline units are used in the vector addition process as shown in FIG. 5, and thus making it possible to perform high-efficiency vector processing.

Specifically, the elements of A[i][0] to A[i][7] are stored in the vector registers of the vector pipeline units 0 to 7 respectively, and the elements of A[i+1][0] to A[i+1][7] are stored in the vector registers of the vector pipeline units 8 to 15 respectively. Similarly, the elements of B[i][0] to B[i][7] and the elements of B[i+1][0] to B[i+1][7] are also stored in the vector pipeline units 0 to 7 and the vector pipeline units 8 to 15 respectively. Further, the elements of the operation results C[i][0] to C[i][7] and the elements of the operation results C[i+1][0] to C[i+1][7] are stored in the vector pipeline units 0 to 7 and the vector pipeline units 8 to 15 respectively.

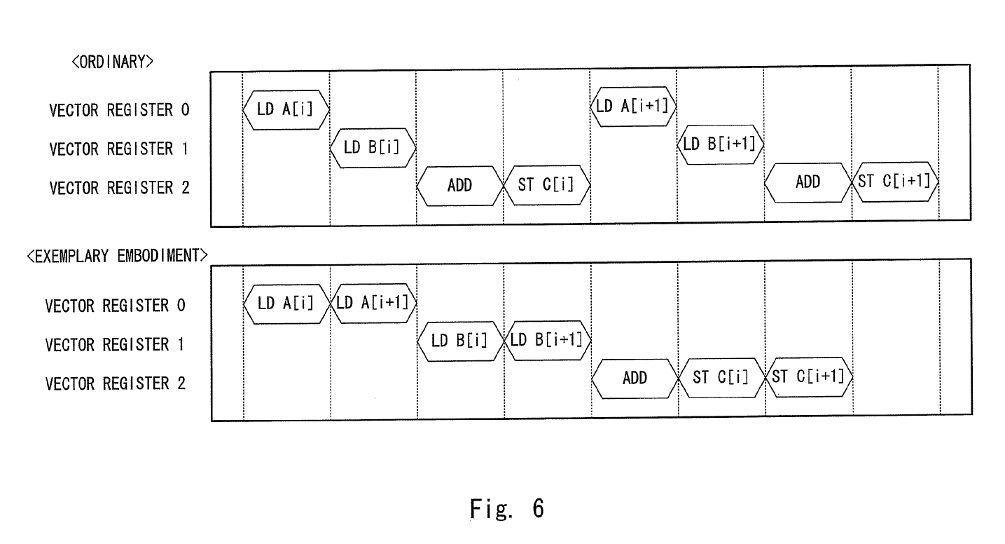

The operation of each vector register is examined here. In the above-described configuration example of an ordinary program, an addition is performed for each short vector as shown in the upper section of FIG. 6. In contrast to this, in the configuration example of a program according to this exemplary embodiment of the present invention, two short vectors are combined into one long vector and an addition is performed for the combined long vector as shown in the lower section of FIG. 6. As a result, it is possible to load and store necessary data with efficiency even in an operation for short vectors, and thus making it possible to improve the use efficiency of the arithmetic unit.

As explained above, according to this exemplary embodiment of the present invention, a vector instruction capable of specifying a range of use of a vector register and a storage pointer generation unit that controls a storage pointer of a vector register are provided. The storage pointer generation unit refers to a vector instruction and controls a storage pointer so that an element of the succeeding vector instruction string can be stored in a specified range of use of a vector register together with the element of the preceding instruction. As a result, it is possible to collectively store elements of successive instructions having a short vector length into a single vector register, and thus making it possible to supply elements without interruption to the arithmetic unit even when the instructions have a short vector length. Consequently, it is possible to improve the use efficiency of the arithmetic unit.

### Second Exemplary Embodiment

In this exemplary embodiment, a modified example of the above-described vector processing apparatus according to the first exemplary embodiment of the present invention is explained. In the above-described first exemplary embodiment, an example in which two short vectors are combined into one vector and then processed as one vector is explained. However, it is also possible to combine more than two short vectors into one vector and then process them as one vector.

In this exemplary embodiment according to the present invention, the vector instruction is an instruction with a successive storage flag accompanied with a successive storage flag for “combining a plurality of short-vector processes for vector-loading m pieces of data from the address of A[i] and storing them into a vector register 0” and a successive storage flag for “combining a plurality of short-vector processes for vector-loading m pieces of data from the address of B[i] and storing them into a vector register 1”. Further, a vector processing apparatus according to this exemplary embodiment can repeat this vector instruction within a range in which the number of elements to be successively stored does not exceed the maximum vector length.

For example, when m is 8 and the maximum vector length is 256 elements, this instruction can be repeated 32 times at the maximum. In this way, it is possible to handle 32 short vectors as one long vector. Therefore, in the vector addition of a vector register 0 and a vector register 1, 8×32 pieces of data are processed all at once, and thus making it possible to improve the vector processing efficiency even further.

### Other Exemplary Embodiments

In the above-described first exemplary embodiment, an example in which the successive storage flag and the vector length are used as the information for specifying the range of use of a vector register(s) is explained. However, “the use start element number of a vector register and the vector length” may be used as the information for specifying the range of use of a vector register, specifically, as “the information for controlling the storage pointer of a vector register”. Alternatively, “the use start element number of a vector register and the end element number” may be used.

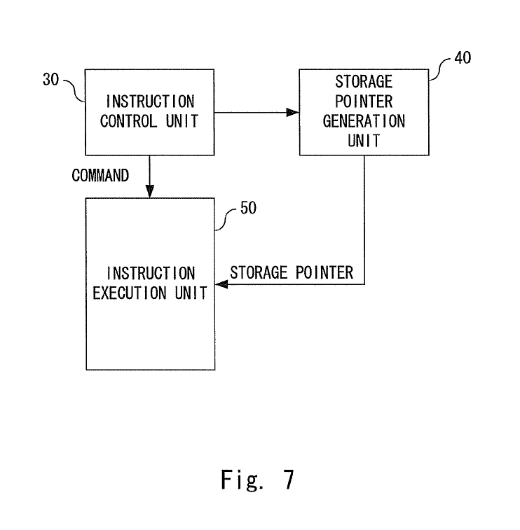

An outline of the present invention explained again hereinafter with reference to FIG. 7. FIG. 7 is a block diagram obtained by extracting only the essential part of the vector processing apparatus according to the present invention. A vector processing apparatus includes an instruction control unit 30 that performs execution control of a vector instruction including information specifying a range of use of a vector register, a storage pointer generation unit 40 that generates a storage pointer indicating a position of a used element of a vector register, and an instruction execution unit 50 including a plurality of vector pipeline units in which a plurality of vector registers are respectively distributed and placed, and parallel processing is performed.

The storage pointer generation unit 40 refers to the vector instruction and controls the storage pointer so that an element of a succeeding vector instruction string can be stored in a specified range of use of the plurality of vector registers together with an element of a preceding vector instruction. The instruction execution unit 50 stores an element into the vector registers in accordance with the storage pointer generated by the storage pointer generation unit.

Two or more of the above-described exemplary embodiments can be combined as desired. Further, the present invention is not limited to the above-described exemplary embodiments, and needless to say, various modifications can be made to them without departing from the scope and spirit of the present invention described above.

The whole or part of the exemplary embodiments disclosed above can be described as, but not limited to, the following supplementary notes. According to the present invention, it is possible to provide a vector processing apparatus and a vector processing method, capable of improving the vector processing efficiency.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A vector processing apparatus comprises:
a storage pointer generation unit that generates a storage pointer value; and
an instruction execution unit that comprises a plurality of vector pipeline units and performs parallel processing of an operation of a vector instruction including a plurality of elements by using a part of or all of the plurality of vector pipeline units, wherein
the storage pointer generation unit receives the vector instruction and range information thereof and generates the storage pointer value indicating a position of use of the plurality of vector pipeline units based on the range information,
when receiving a succeeding vector instruction being able to be processed in parallel together with a preceding vector instruction, the storage pointer generation unit updates the storage pointer value based on the range information so as to input each element of the succeeding vector instruction into a vector pipeline unit that is unused by the preceding vector instruction, and
the instruction execution unit processes in parallel the preceding vector instruction and the succeeding vector instruction being able to be processed together with the preceding vector instruction according to the storage pointer value.

2. The vector processing apparatus according to claim 1, wherein
the vector instruction includes a successive storage flag indicating whether or not the vector instruction should be processed in parallel together with the preceding vector instruction and a vector length specifying a range of use of a vector pipeline unit used by the vector instruction, and
the storage pointer generation unit generates the storage pointer value by updating a value of the vector length based on the successive storage flag.

3. The vector processing apparatus according to claim 2, wherein when the succeeding vector instruction is processed in parallel together with the preceding vector instruction based on the successive storage flag, the storage pointer generation unit updates the storage pointer value by adding the vector length of the succeeding vector instruction to the vector length of the preceding vector instruction, whereas when the succeeding vector instruction is not processed in parallel together with the preceding vector instruction together, the storage pointer generation unit uses an initial value as the storage pointer value.

4. The vector processing apparatus according to claim 1, wherein
each of the vector pipeline units includes at least two vector registers and an arithmetic unit, and
the arithmetic unit performs arithmetic processing based on a value stored in one of the vector registers and stores a processing result into another of the vector registers.

5. The vector processing apparatus according to claim 4, further comprising an instruction control unit that controls storing of a vector element into a vector register in the vector pipeline unit and reading of a vector element from a vector register in response to the vector instruction.

6. A vector processing method for a vector processing apparatus that comprises an instruction execution unit comprising a plurality of vector pipeline units, the vector processing method comprising:
a storage pointer generation step of generating a storage pointer value indicating a position of use of the plurality of vector pipeline units, and
an instruction execution step of performing parallel processing of an operation of the vector instruction including a plurality of elements by the plurality of vector pipeline units,
wherein
the vector instruction includes range information specifying a range of use of the plurality of vector pipeline units,
in the storage pointer generation step, when a succeeding vector instruction being able to be processed in parallel together with an preceding vector instruction is received, the storage pointer value is updated based on the range information so that each element of the succeeding vector instruction is input into a vector pipeline unit that is unused by the preceding vector instruction, and
in the instruction execution step, the preceding vector instruction and the succeeding vector instruction being able to be processed together with the preceding vector instruction are processed in parallel according to the storage pointer value.

7. The vector processing method according to claim 6, wherein
the vector instruction includes a successive storage flag indicating whether or not the vector instruction should be processed in parallel together with the preceding vector instruction and a vector length specifying a range of use of a vector pipeline unit, and
in the storage pointer generation step, the storage pointer value is generated by updating a value of the vector length based on the successive storage flag.

8. The vector processing method according to claim 7, wherein in the storage pointer generation step, when the succeeding vector instruction is processed in parallel together with the preceding vector instruction based on the successive storage flag, the storage pointer value is updated by adding the vector length of the succeeding vector instruction to the vector length of the preceding vector instruction, whereas when the succeeding vector instruction is not processed in parallel together with the preceding vector instruction, an initial value is used as the storage pointer value.
